(19) United States
(12) Patent Application Publication
(10) Pub. No.: US 2005/0104388 A1
(43) Pub. Date: May 19, 2005

(54) Slide latch assembly

(76) Inventor: Allen J. Takes, Cascade, IA (US)

Correspondence Address: BAKER & DANIELS, 300 NORTH MERIDIAN STREET, SUITE 2700, INDIANAPOLIS, IN, 46204-1782, US

(21) Appl. No.: 10/972,272

(22) Filed: Oct. 22, 2004

Related U.S. Application Data
(60) Provisional application No. 60/520,130, filed on Nov. 13, 2003.

(51) Int. Cl. E05C 17/32

(52) U.S. Cl. 292/336.3

(57) ABSTRACT

The present invention provides a slide latch assembly for securing a wall panel to a second wall or a post. The slide latch assembly includes a vertical member configured to receive a wall panel, at lease one latch member, and a handle member operably connected to the at least one latch member. The latch member is capable of engaging a complementary engaging structure provided on a second wall and pulling a leading edge of the vertical member abutting the second wall. The handle member is slidable in a first direction to actuate the at least one latch member into an unlatched position, wherein each latch member pivotally projects from the leading edge for engaging the complementary engaging structure. The handle member is slidable in a second direction to actuate the at least one latch member into a latched position, wherein each latch member retracts into the vertical member. The slide latch assembly further includes a sliding member slidable within the vertical member, and operably connected between the handle member and the at least one latch member.

This application claims benefit of U.S. Provisional Patent Application No. 60/520,130 filed Nov. 13, 2003.

### TECHNICAL BACKGROUND

1. Field of the Invention

The present invention relates to sliding or folding walls, particularly a device for securing a wall panel to another wall or a wall post.

2. Description of the Related Art

Partition walls are commonly used in many public buildings to separate an area of a room from another area. The partition walls are usually made of wall panels that are linked together by hinges. The panels may be folded or stacked together in a storage position, or slidingly expanded or unfolded to form a wall. Each partition wall may have a leading panel that may be equipped with a latch assembly capable of securing the partition wall to a stationary wall or a post.

A drawback for a typical latch assembly is that it provides only one latch to secure the door panel to the stationary wall. For a taller wall, the upper portion of the wall panel that has no latch mechanism may not be tightly secured to the stationary wall. Although a plurality of latches have been provided for a fire wall in one specific example (U.S. Pat. No. 4,834,161), such plurality of latches can be moved from an unlatched position to a latched position only when the mechanism is activated by heat from the fire.

### SUMMARY OF THE INVENTION

The present invention provides a novel slide latch assembly having at least one latch for securing a wall panel to a second wall or a post. Most of the moving components of the latch assembly of the present invention are enclosed within a vertical member of the panel, making the latch easy to operate and aesthetically pleasing.

In one embodiment, the slide latch assembly includes a vertical member configured to receive a wall panel, at least one latch member, and a handle member operably connected to the at least one latch member. The handle member is slidable in a first direction to actuate the at least one latch member into an unlatched position, wherein each latch member pivotally projects from a leading edge of the vertical member for engaging a complementary engaging structure provided on a second wall. The handle member is slidable in a second direction to actuate the at least one latch member into a latch position.

In a specific embodiment, the slide latch assembly includes a sliding member slidable within the vertical member. Each latch member has a first end pivotally attached to the sliding member, and a second end for engaging the complementary engaging structure provided on the second wall.

In one form of the present invention, the handle member includes a first handle and a second handle operably attached to opposite sides of the sliding member and cooperatively move the sliding member in either the first or the second direction. The handle member further includes a cross pate having a first end attached to the first handle and the second end attached to the second handle. The cross plate has a center portion attached to the sliding member. The cross plate may be attached to a bottom end of each handle.

In one aspect of the invention, the vertical member includes a first sidewall defining a first elongated slot and a second sidewall defining a second elongated slot. The first and second sidewalls form a groove behind the leading edge. The cross plate of the handle member extends across the groove of the vertical member and through the first and second elongated slots.

In another aspect of the invention, the handle member further includes a first slide plate affixed on the first sidewall for keeping the first handle from rubbing the first sidewall and a second slide plate affixed on the second sidewall for keeping the second handle from rubbing the second sidewall. The first slide plate defines a first plate slot for aligning with the first elongated slot and the second slide plate defines a second plate slot for aligning with the second elongated slot. The first and the second handles move between the first and second directions along the first and second plate slots.

In another aspect of the invention, each handle defines a base portion that may extend to completely cover the plate slots when the latch members are in the latched position.

In a specific embodiment, each base portion of the handle defines an elongated bushing, and each slide plate may further define a track for receiving the bushing. The bushing received within the track keeps the handle from twisting when the handle is pulled in operating the wall panel.

In another aspect of the invention, the leading edge of the vertical member defines at least one elongated opening for receiving the at least one latch member therethrough. The second end of each latch member defines an engaging element protruding from the elongated opening. The engaging element may include a T-bar for engaging the complementary engaging structure such as a strike pull latch attached to the second wall.

In an exemplary embodiment, the sliding member may define a channel, having a fastener extending thereacross for pivotally attached to the first end of each latch member. The latch member may be configured in a curve shape that allows the latch member to project upwardly and outwardly from the elongated opening in the unlatched position, or retract inwardly and downwardly of the vertical member in the latched position.

In another exemplary embodiment, at least one latch guide and/or a plurality of pins may be provided for guiding the movement of the sliding member within the groove. Each latch guide may define a base attached to the leading edge of the vertical member and a guide portion protruding into the channel of the sliding member. The sliding member moves upwardly or downwardly about the latch guide. Similarly, each pin may be fastened on sidewalls of the vertical member and threaded through pin slots disposed on sliding member to keep the sliding member moving upwardly or downwardly in place.

In another exemplary embodiment, the slide latch assembly may further include a lock assembly for locking the latch member in the latched position.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1A is a front perspective view of a slide latch assembly according to one embodiment of the present invention, showing latch members in a latched position;

FIG. 1B is a front perspective view of a slide latch assembly according to the embodiment in FIG. 1A, showing the latch members in an unlatched position;

FIG. 2 is an exploded perspective view of a slide latch assembly according to another embodiment of the present invention;

FIG. 3A is a side elevation view of a handle according to the embodiments in FIGS. 1A, 1B and 2;

FIG. 3B is a bottom elevation view of the handle according to the embodiment in FIG. 3A;

FIG. 4A is a front elevational view of a slide plate according to one embodiment of the present invention;

FIG. 4B is a side elevational view of a slide plate according to the embodiment of FIG. 4A;

FIG. 5 is a side perspective view of a latch member and a strike pull latch according to one embodiment of the present invention;

FIG. 6A is a front perspective view of the latch assembly including a latch guide, according to a second embodiment of the present invention;

FIG. 6B is a partial exploded perspective view of a latch guide according to the embodiment shown in FIG. 6A;

FIG. 7A is a front elevational view of the slide latch assembly according to one embodiment, showing a handle member in an up position;

FIG. 7B is an enlarged front elevational view of a portion of the slide latch assembly shown in FIG. 7A;

FIG. 8 is a front elevational view of the slide latch assembly according FIG. 7A, showing a handle member in a down position;

FIG. 9 is a side perspective view of the slide latch assembly of a third embodiment showing a cross plate attachment to a handle member.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The present invention provides a slide latch assembly for securing a wall panel in a closed position against a second wall, a wall post or another wall panel. The slide latch assembly of the present invention may be suitable for used with a sliding wall, a folding wall, or any other movable wall such as an audio wall or a fire wall.

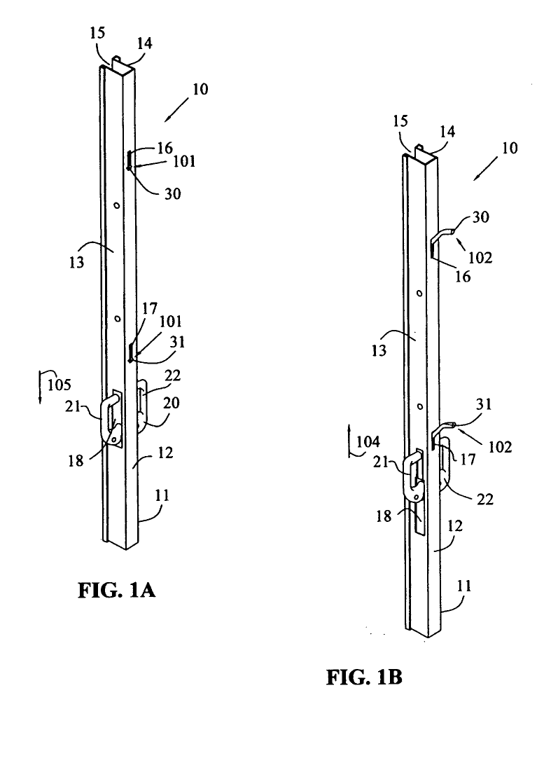

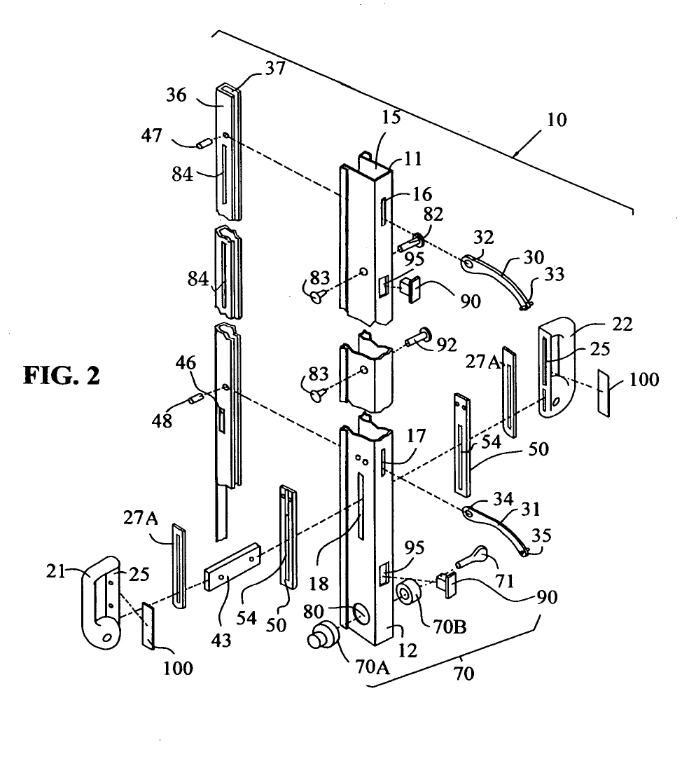

Referring to FIGS. 1A, 1B and 2, slide latch assembly 10 shown includes vertical member 11 defining leading edge 12, first sidewall 13 and second sidewall 14. First sidewall 13 and second sidewall 14 form groove 15 behind leading edge 12. Vertical member 11 may be formed of any suitable material known in the art. For example, aluminum, steel or a synthetic polymer may be molded or extruded to form vertical member 11. The size and dimension of vertical member 11 may vary to accommodate differing sizes of the wall panel to be fitted to vertical member 11. Vertical member 11 may typically be used with a wall of about 6 feet (1.8 m) to about 18 feet-2 inches (5.5 m) tall. However, vertical member 11 is adaptable to be used with walls below 6 feet (1.8 m) or above 18 feet-2 inches (5.5 m). A wall panel may be fastened to sidewalls 13 and 14 of vertical member 11 in any suitable manner known in the art.

As shown in FIGS. 1A and 1B, leading edge 12 of vertical member 11 defines two elongated openings 16-17 spaced at a pre-determined distance apart from one another along leading edge 12. It is contemplated that leading edge 12 may have any number of elongated openings. The exact number of openings depends on the number of latches desired for a particular wall height. With a taller wall, two or more latches may be practical. Each elongated opening is configured to receive a substantial portion of a latch member, which will be described hereinbelow.

Illustrated in the exploded view in FIG. 2, slide latch assembly 10 further includes sliding member 36 which is a three-sided elongated structure defining channel 37 extending along sliding member 36 facing leading edge 12 of vertical member 11. Sliding member 36 is slidable upwardly or downwardly within groove 15. Like vertical member 11, sliding member 36 may be made of any suitable material such as aluminum, steel or plastic. Vertical member 11 and sliding member 36 may be made of the same or different material.

Sliding member 36 is attached to at least one latch member capable of engaging a complementary engaging structure provided on a second wall or a wall post. The number of latch members depends on the number of elongated openings provided on sidewalls 13-14 such as elongated openings 16 and 17. The embodiment in FIGS. 1A, 1B, and 2, shows two latch members 30-31.

Latch member 30 defines first end 32 pivotally attached to sliding member 36, and second end 33 for engaging the complementary engaging structure. Similarly, latch member 31 defines first end 34 pivotally attached to sliding member 36, and second end 35 for engaging the complementary engaging structure. Fasteners 47 and 48 may be provided to fasten first ends 32 and 34, respectively, to sliding member 36.

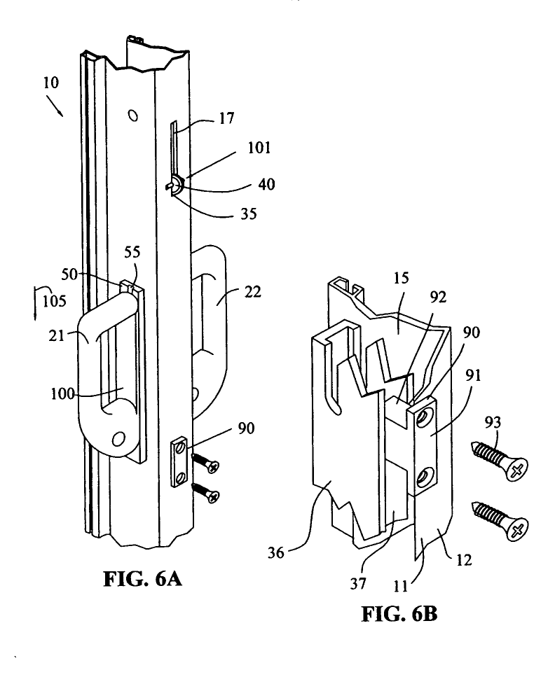

In one example, shown in FIG. 5, latch member 31 includes hole 40 disposed at first end 34 for receiving fastener 47 (FIG. 2) therethrough. First end 34 may pivot about fastener 47 within channel 37 (FIG. 2). Further shown in FIG. 5, second end 35 of latch member 31 defines engaging element 39 in a form of T-bar 40. T-bar 40 projects outwardly from latch member 31 to expand at a width larger than the width of elongated opening 17 such that T-bar 40 remains outside elongated opening 17 at all time (see FIGS. 1A, 1B and 6A). It is contemplated that instead of T-bar 40, engaging element 39 may be in any other shape or form such as a circular or rectangle plate or a ball that is engagable to complementary engaging structure 60, as shown in FIG. 5.

As further shown in FIGS. 1A and 1B, sidewalls 13-14 define elongated slots 18 in communication with groove 15 and aligned to one another. Elongated slots 18 may be positioned at a suitable height from the bottom of vertical member 11 or the floor, especially at a height reachable by any user.

Further included in slide latch assembly 10 is handle member 20, which, as shown in FIGS. 1A, 1B and 2, defines two handles 21-22. Handles 21-22 are mounted to sliding member 36 by means of cross plate 43 that is connected to sliding member 36 and extends across groove 15 and through elongated slots 18. Handle 21 is disposed on sidewall 13 and handle 22 is disposed on sidewall 14. Handles 21-22 move cooperatively upwardly to up position 104 (FIG. 1B) or downwardly to down position 105 (FIG. 1A) along elongated slots 18, causing sliding member 36 and latch members 30-31 to move cooperatively upwardly or downwardly.

Further demonstrated in FIG. 2, handle member 20 may include a pair of slide plates 50. As shown in FIGS. 4A-4B, each of slide plates 50 defines an elongated plate slot 54 through which cross plate 43 extends to attach to handles 21-22 (see FIG. 9). Each of slide plates 50 may further define track 55 extending beyond plate slot 54 for receiving elongated bushing projecting from each handle 21, 22 (to be described hereinbelow). Each of slide plates 50 is affixed to sidewalls 13 and 14, such that elongated slots 18 are in alignment with elongated plate slot 54, which may extend substantially the same length as elongated slots 18 on vertical member 11. It is noted that the length of plate slots 54 may be any suitable length such as about 5.25 inches (13.3 cm) to allow the up and down movement of cross plate 43.

It is contemplated that dummy plates (not shown) may be provided for aesthetic purpose or for protecting the sidewalls of the vertical member. Each dummy plate may have similar features as slide plate 50, but with a shorter elongated plate slot for use with handles that are not slidable or may be slightly slidable. The dummy plates may be affixed to the sidewalls of a vertical member similar to vertical member 11.

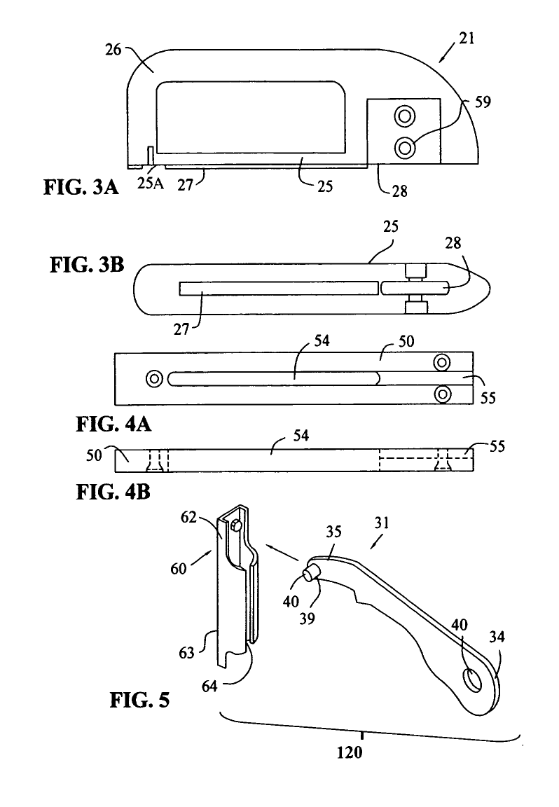

As shown in FIG. 3A, each handle 21, 22 defines handheld portion 26 to be held by a user and base portion 25. Base portion 25 defines sliding side 25A, and connection region 28 for receiving one end of cross plate 43 (shown in FIGS. 2 and 9). Each handle 21, 22 may be formed of a one piece die cast. Connection region 28 may define a well extending into handle portion 26. Any suitable fastening means 59 such as rivets or screws may be used to fasten each end of cross plate 43 to handles 21-22. In the specific embodiment shown in FIG. 3A, sliding side 25A further defines elongated bushing 27 configured to be slidable within track 55 of slide plate 50 in order to prevent handle 21, 22 from twisting when handle 21, 22 is pulled in order to move the wall panel between a closed and an open position, or when the handle 21, 22 is moved into up position 104 or down position 105.

In another specific embodiment, slide bushing 27A (FIG. 2) may be provided for attaching on sliding side 25A of base portion 25 to prevent wear. Slide bushing 27A may be made of any suitable material such as a thin piece of MDS-filled nylon 6/6 of about 1/32 inch (0.8 mm) thick, and may have adhesive applied on one side for attaching to base portion 25. As illustrated in FIG. 2, slide bushing 27A defines elongated bushing slot 27B for receiving bushing 27 of base portion 25 therethrough.

Further shown in FIG. 2, cross plate 43, having one end attached to handle 21, is threaded through first slide bushing 27A, first slide plate 50, first sidewall 13 through pair of slot 46 of sliding member 36, through sidewall 14, second slide plate 50, and second slide bushing 27A, to be attached to handle 22 at the opposite end of cross plate 43. Cross plate 43 may be configured as a thin plate (see FIG. 9) that includes sufficient surface area and strength to take the force of pulling open and closing of the wall panel or the wall. Cross plate 43 may be relatively wider and thinner than traditional fasteners. This specific configuration of cross plate 43 allows elongated slots 18 on vertical bar 11, and plate slots 54 on slide plates 50 to be narrower than slots used for conventional handles.

As illustrated in FIG. 9, handles 21-22 are connected together by cross plate 43, at the bottom region of handles 21-22 only. With one connection at the bottom, it is possible to keep plate slots 54 covered under base portion 25 when handles 21-22 are in down position 105. This configuration allows the overall length of each slide plate 50 to be kept relatively short, i.e. 8.25 inches (20.9 cm). Plate slots 54 and elongated slots 18 are only seen when handles 21-22 are operated or moved to up position 104.

In contrast, the conventional handles are usually connected at the top and bottom with two fasteners, or cross bolts. Because they are fastened at the top and bottom, two separate slots, or one very long slot is needed on each side of the vertical member. Further, the conventional handles may not have the base portion like base portion 25 (See FIG. 9) for covering the elongated slots. Therefore the elongated slots may always be visible whether the handle is in the up or down position. In order to cover the slots, escutcheon plates have been used for mounting on the handles. The conventional escutcheon plates are usually much longer than the handle in order to cover the slots in an up or down position. If a choice is made to only cover the slots in a down position, the handle cannot be placed in the center of the escutcheon plate giving it an unbalanced look. The conventional escutcheon plate may be as long as 12¾ inches (32.4 cm), which is much longer than slide plates 50 or base portion 25.

In addition, the conventional escutcheon plates are normally attached to the handles, not the sidewalls of the vertical member. Therefore, they move up and down with the conventional handles and may rub on the sidewalls of the vertical member. While the conventional handles do prevent twisting because of top and bottom cross connections, they have less surface area contacting the operable wall or the wall panel when they are being pulled one way or the other.

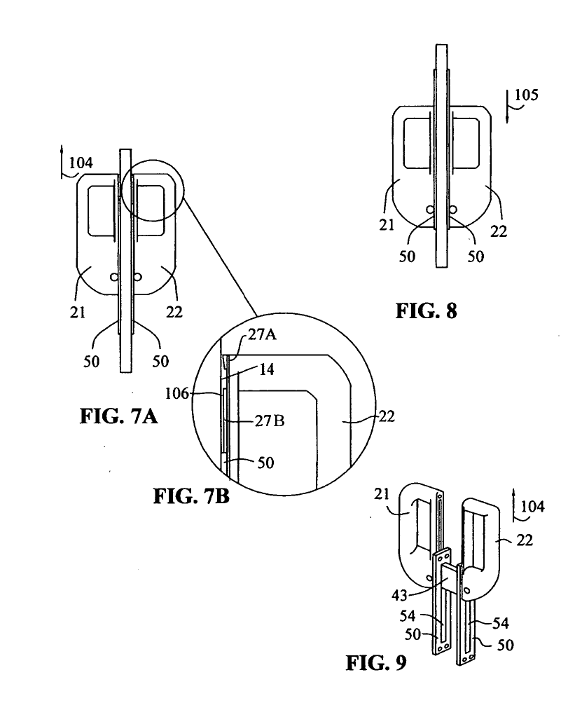

Further, as shown in FIGS. 7A and 7B, when handles 21-22 are in up position 104, the top part of each handle 21, 22 extends beyond slide plate 50. As illustrated in FIG. 7B, the thickness of slide plate 50 forms clearance 106 between sidewall 14 (or 13) of vertical member 11 and bushing 27 of handle 21, 22. Clearance 106 may be of any width, however, clearance of about 0.125 inches (3.175 mm) is acceptable. This feature helps preventing handles 21-22 from rubbing against sidewalls 13-14.

Slide latch assembly 10 may also include handle label 100 affixed on an outer surface of base portion 25 of handles 21-22, as shown in FIGS. 2 and 6A. Label 100 may indicate the direction of handle 21 and/or handle 22 that will place latch members 30-31 in either latched position 101 or unlatch position 102.

In an exemplary embodiment, illustrated in FIG. 2, slide latch assembly 10 may further include a lock assembly for locking latch members 30-31 in latched position 101. The lock assembly may be in any suitable configuration known in the art. As an example, lock assembly 70, having parts 70A and 70B, may be provided to engage sliding member 36 when sliding member 36 is in a down position, in which latch members 30-31 are in latched position 101. Locking assembly parts 70A-70B are attached to opposite sidewalls 13-14 through pair of holes 80 provided on sidewalls 13-14. Either part 70A or 70B or the combination thereof defines an engaging part for engaging sliding member 36. Either part 70A or 70B or both may have a keyhole for receiving key 71 for operating locking member 70.

As further demonstrated in FIG. 2, slide latch assembly 10 may include at least one latch guide 90 and optionally at least one pin 82 attached to vertical member 11 for guiding sliding member 36 within groove 15 of vertical member 11. As shown in a further detail in FIGS. 6A and 6B, latch guide 90 defines base 91 and guide portion 92. Base 91 of latch guide 90 is mounted to leading edge 12 of vertical member 11 so that guide portion 92 protrudes into groove 15 and positioned loosely within channel 37 of sliding member 36. Several latch guides 90 may be provided along the length of vertical member 11. Each latch guide 90 may be placed at a suitable distance apart from one another to keep sliding member 36 moving straight upwardly or downwardly about latch guides 90 and within groove 15.

As further shown in FIG. 2, pins 82 may be fastened between sidewalls 13 and 14 across groove 15 of vertical member 11. Pins 82 extend through elongated pin slots 84 defined on sliding member 36. When sliding member 36 moves up or down, pin slots 84 move up or down about pins 82. Consequently, sliding member 36, being kept straight in place while it moves, keeps each latch member 30, 31 pivoting in a precise position that is aligned with each complementary engaging structure 60 provided on or embedded in the second wall or the wall post.

As shown in FIG. 5, complementary engaging structure 60 is in a form of strike pull latch 62, which defines attachment side 63 for mounting on the wall or the wall post, and engagement side 64 for holding engaging element 39 or T-bar 40 of latch member 30, 31. It is understood that complementary engaging structure 60 may be in any other form that may complementarily engage to engaging element 39. It is also understood that complementary engaging structure 60 may be mounted at a position below the surface of the second wall or the wall post so that leading edge 12 of vertical member 11 is snuggly pressed into the second wall or the wall post when latch members 30-31 are in latched position 101.

To operate slide latch assembly 10, a user may hold on to handle 21 or 22 of handle member 20 to pull or slide the door panel into an open or closed position. During this movement, handle member 20 may be in an up position (FIG. 1B), in which latch members 30-31 project upwardly and outwardly in unlatch position 102. Alternatively handle member 20 may be in down position 105 (FIG. 1A), in which latch members 30-31 project downwardly and inwardly in latch position 101. When leading edge 12 of slide latch assembly 10 comes close to the wall post, handle member 20 must be in an up position 104 (FIG. 1B) so that latch members 30-31 may come into engagement with complementary engaging structure 60.

As shown in FIG. 5, latch member 31 may be pushed against strike pull latch 62 when the user slides the door panel against the second wall or the wall post where strike pull latch 62 is mounted thereon. Strike pull latch 62 may be mounted slightly lower than second end 35 of latch member 31 when latch member 31 is fully extended upwardly. When second end 35 almost touches the second wall slightly above strike pull latch 62, the user may pull down handle member 20 to actuate a downward movement of latch member 31 of about 7/8 inches (about 2.2 cm). T-bar 40 moves into channel 62A and latch member 31 simultaneously retracts back into groove 15 of vertical bar 11, pulling on strike pull latch 62 causing the door panel to abut the second wall or the door post. If strike pull latch 62 is slightly embedded within the second wall or the wall post, leading edge 12 of vertical member 11 will be hidden within the second wall or the wall post. If a lock assembly such as lock assembly 70 shown in FIG. 2 is provided, slide latch assembly 10 may be locked in latched position 101, see FIGS. 1A and 6A.

To unlatch slide latch assembly 10 from the second wall or the wall post, a user may unlock lock assembly 70 and pull up either handle 20 or 21, depending on which side of the wall panel the user is operating. When handle member 20 is moved upwardly, sliding member 36 moves upwardly, causing the first ends 32 and 34 of latch members 30 and 31 to move upwardly. At the same time second ends 33 and 35 move upwardly (see FIG. 1B), and disengage from strike pull latch 62, pushing leading edge 12 away from the second wall or the wall post. The wall panel can then be moved into the open position.

Slide latch assembly 10 of the present invention is low cost and easy to assemble. Since most moving components are positioned within vertical member 11, slide latch assembly 10 of the present invention is aesthetically pleasing and easy to operate. Another benefit of the slide latch assembly 10 is that a single handle member, such as handle member 20 may operate a plurality of latch members that are spaced along vertical member 11. In this way, a very tall wall panel can be uniformly and tightly secured onto a second wall or a wall post.

It is further foreseeable that the operation of handle member 20 may be configured to be performed by a control device which may be remotely operated by a user or automatically operated by a computerized system. In such configuration, handle member 20 affects the up or down movement of sliding member 36, and subsequently actuates the pivotal movement of latch members 30-31, as above-described.

While the present invention has been described as having a exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A slide latch assembly for latching a wall panel to a second wall comprising:
a vertical member configured to be attached to a wall panel, said vertical member having a leading edge disposed oppositely to the wall panel;
at least one latch member for engaging a complementary engaging structure provided on a second wall and pulling said leading edge abutting the second wall; and
a handle member operably connected to said at least one latch member, said handle member slidable in a first direction to actuate said at least one latch member into an unlatched position, wherein each latch member pivotally projects from said leading edge for engaging the complementary engaging structure, and said handle member slidable in a second direction to actuate said at least one latch member into a latched position, wherein each latch member pivotally retracts into said vertical member.

2. The slide latch assembly of claim 1, wherein each of said at least one latch member vertically spaced from said handle member.

3. The slide latch assembly of claim 2, further comprising:
a sliding member slidable within said vertical member, and operably connected between said handle member and said at least one latch member.

4. The slide latch assembly of claim 3, wherein said at least one latch member is pivotally fastened to said sliding member.

5. The slide latch assembly of claim 3, wherein said handle member comprises a first handle and a second handle operably attached to opposite sides of said sliding member and cooperatively move sliding member in either the first or the second direction.

6. The slide latch assembly of claim 5, wherein said handle member further comprises a cross plate having a first end attached to said first handle and a second end attached to said second handle, said cross plate having a center portion attached to said sliding member.

7. The slide latch assembly of claim 6, wherein said cross plate is attached to bottom ends of said first and second handles.

8. The slide latch assembly of claim 6, wherein said vertical member defines a groove between a first sidewall and a second sidewall, said first sidewall defining a first elongated slot and a second sidewall defining a second elongated slot, wherein said cross plate extends across said groove and through said first and second elongated slots.

9. The slide latch assembly of claim 8, wherein said handle member further comprises a first slide plate affixed on said first sidewall for keeping said first handle from rubbing said first sidewall, and a second slide plate affixed to said second sidewall for keeping said second handle from rubbing said second sidewall.

10. The slide latch assembly of claim 9, wherein said first and second slide plates are configured to cooperate with said first and second handles to prevent said first and second handles from having a twisting movement.

11. The slide latch assembly of claim 9, wherein said first slide plate defines a first plate slot for aligning with said first elongated slot and said second slide plate defines a second plate slot for aligning with said second elongated slot, and wherein said cross plate extending across said groove, through said first and second elongated slots and said first and second plate slots.

12. The slide latch assembly of claim 11, wherein each of said first and second handles defines a base portion configured to cover each of said plate slots after said handle member is moved in the second direction to a down position.

13. The slide latch assembly of claim 12, wherein said base portion of said first and second handles defines an elongated bushing, and wherein each of said first and second slide plates defines a track for receiving said elongated bushing, said elongated bushing slidable within said track.

14. The slide latch assembly of claim 12 further comprising a pair of slide bushings, each attached to said base portion of each of said first and second handles for preventing wear on said base portion and said slide plate.

15. The slide latch assembly of claim 4, wherein said at least one latch member defines a first end pivotally fastened to said sliding member and a second end projecting from at least one elongated opening disposed on said leading edge of said vertical member.

16. The slide latch assembly of claim 15, wherein said second end of said at least one latch member forming an engaging element for engaging said complementary engaging structure provided on the second wall.

17. The slide latch assembly of claim 16, wherein said engaging element defines a T-bar for engaging said complementary engaging structure.

18. The slide latch assembly of claim 17, wherein said complementary engaging structure includes a strike pull latch.

19. The slide latch assembly of claim 4, wherein said sliding member defines a channel having at least one fastener extending thereacross for pivotally fastening said first end of said at least one latch member within said channel.

20. The slide latch assembly of claim 19 further comprising at least one latch guide protruding from said vertical member into said channel of said sliding member for keeping said sliding member sliding straight over said at least one latch guide within said vertical member.

21. The slide latch assembly of claim 20, wherein each latch guide defines a base attached to said leading edge of said vertical member, and a guide portion protruding into said channel of said sliding member.

22. The slide latch assembly of claim 20, wherein a plurality of latch guides are provided along said vertical member.

23. The slide latch assembly of claim 19 further comprising a plurality of pins attached to said vertical member, extending through said channel for keeping said sliding member sliding straight within said vertical member.

24. The slide latch assembly of claim 23 wherein said sliding member defines elongated pin slots for receiving said plurality of pins.

25. The slide latch assembly of claim 1, wherein said at least one latch member defines a curve shape.

26. The slide latch assembly of claim 1 further comprising a lock assembly for locking said latch member in said latched position.
